(19) United States
(12) Patent Application Publication
(10) Pub. No.: US 2013/0335825 A1
(43) Pub. Date: Dec. 19, 2013

(54) Method of Manufacture of X-Ray Diffraction Gratings

(71) Applicant: The Board of Trustees of the University of Illinois, (US)

(72) Inventors: Peter Abbamonte, Urbana, IL (US); Scott MacLaren, Champaign, IL (US)

(73) Assignee: The Board of Trustees of the University of Illinois, Urbana, IL (US)

(21) Appl. No.: 13/779,299

(22) Filed: Feb. 27, 2013

Related U.S. Application Data
(60) Provisional application No. 61/659,186, filed on Jun. 13, 2012.

(51) Int. Cl. G02B 5/18

(52) U.S. Cl. CPC G02B 5/1852; G02B 5/18
USPC 359/566; 264/2.7

(57) ABSTRACT

Methods and apparatus for manufacturing an optical grating, and the optical grating manufactured thereby. A workpiece is secured to a carriage driven by a linear actuator. A tool is maintained in contact with the workpiece at either a constant force or a constant displacement normal to the surface of the workpiece while the carriage is translated. A plurality of grooves is ruled into the workpiece in this manner.

The present application claims the priority of U.S. Provisional Patent Application, Ser. No. 61/659,186, filed Jun. 13, 2012, which is incorporated herein by reference.

This invention was made with government support under Grant DMR 0703406, awarded by the National Science Foundation. The Government has certain rights in the invention.

### FIELD OF INVENTION

The present invention relates to an apparatus and to methods of manufacture of diffraction gratings and, more particularly, to certain x-ray diffraction gratings manufacturable exclusively in accordance with such methods.

### BACKGROUND ART

The crafting of precision diffraction gratings has long been considered a refined art, the early development of which was systematically summarized in Harrison, The Production of Diffraction Gratings: I. Development of the Ruling Art, in J. Opt. Soc. Amer., 39, pp. 413-26 (1949), the first of a series of papers on the subject by George R. Harrison, incorporated herein by reference. Aden, The Present Condition of Rowland's Ruling Machines, Astrophys. J., 23, 348-50 (1906), prepared on acquisition of the Rowland ruling engines by what is, today, Harvard's Collection of Historical Scientific Instruments, attests to the regard accorded the craftsmanship of early ruling engines.

Salient components of a classic ruling engine may be identified in FIG. 1, which depicts a prior art ruling engine designated generally by numeral 100. Grating blank 102 is secured to grating carriage 104 such that diamond tool 106 scores grooves across the face of the grating blank as the diamond tool is impelled by motion imparted to the diamond tool via drive shaft 108 and a mechanism for converting rotary to linear motion via crank 110, connecting rods and linkages 112, and rocking arm 114. Diamond tool 106 is shaped to impart a specified blaze angle to the ruled groove. As each pass across the blank 102 is completed, diamond tool 106 is lifted from the face of blank 102 through activation of diamond lifting mechanism 114. Linear motion of tool 106 is interrupted by disengagement of clutch 116, and carriage 104 is advanced, by a specified ruling pitch, along a slideway 117 in a direction transverse to the direction of the ruled groove. Advancement of carriage 104 is via cam 118 and reduction gears 120 and engagement of screw 122 with nut 124. Carriage 104 is stabilized by outrigger wheel 126 guided by rail 128. Motion imparted to blank 102 via carriage 104 may be monitored interferometrically using interferometer 130, illuminated and monitored via collimating lens 134 and aperture 132. Overall control is governed by electronics 140.

As was apparent from early days, ruling engines based on lead screws are prone to periodic errors due to irregularities in the threads of screw 122 and nut 124, which, in turn, give rise to spectral “ghosts.”

Additionally, to the extent to which the material of blank 102 is inhomogeneous or imperfect, even on the scale of several atomic layers, pressure variations of diamond tool 106 may cause imperfections in the ruling of grooves, randomly scattering some of the light and creating a less efficient grating.

Finally, ruling engines of the classic prior art variety are limited to ruling substantially parallel grooves, with all grooves characterized by identical blaze profiles.

The foregoing deficiencies call for improvements in the apparatus and manufacturing techniques of fabrication of gratings, particularly those free of periodic errors and exhibiting the extreme uniformity requirements of those used at very short wavelengths such as in the vacuum ultraviolet and soft-x-ray regions of the electromagnetic spectrum.

### SUMMARY OF EMBODIMENTS OF THE INVENTION

In accordance with embodiments of the present invention, methods are provided for manufacturing an optical grating. The methods have steps of:

a. securing a workpiece blank to a surface of a carriage;

b. translating the carriage in a first direction by means of a linear actuator;

c. maintaining a tool in contact with a surface of the workpiece blank at one of a constant force and a constant displacement normal to the surface of the workpiece blank during the step of translating the carriage in a first direction, thereby ruling a groove in the surface of the workpiece blank;

d upon completion of the groove in the surface of the workpiece blank, translating the carriage in a second direction substantially transverse to the first direction; and

e. repeating steps (b), (c) and (d) in such a manner as to rule a plurality of grooves, constituting, in the aggregate, a grating surface.

In accordance with further embodiments of the present invention, the step of maintaining the tool in contact with the surface of the workpiece blank may be performed by means of an atomic force microscope. The tool may be a diamond tip or another tip of suitable hardness. The tool may be shaped by ion milling, or polishing, or by another process.

In other embodiments of the present invention, the linear actuator may be a linear induction motor. There may be a further step of measuring the translation of the carriage in the second direction by means of an interferometer.

In accordance with alternate embodiments of the present invention, an optical grating is provided that is manufactured in accordance with any of the methods heretofore described, wherein the optical grating has substantially no periodic excursion from parallelism of the plurality of grooves. Alternatively, the optical grating manufactured as described may have specified excursions from parallelism of the plurality of grooves.

In particular further embodiments of the invention, the optical grating may have parallel grooves of variable spacing. It may have non-intersecting curved grooves or a fork discontinuity.

In yet further embodiments of the present invention, an apparatus is provided for manufacturing an optical grating. The apparatus has a linear actuator for translating a workpiece blank in a plurality of directions relative to a shaped diamond tip, and an atomic force microscope for retaining the shaped diamond tip relative to a surface of the workpiece blank subject to one of a constant force and a constant displacement normal to the surface of the workpiece blank. In some embodiments, the linear actuator may be a linear induction motor.

### BRIEF DESCRIPTION OF THE DRAWINGS

Advantages of the present invention and its several improvements will be seen when the following detailed description is read in conjunction with the attached drawings. These drawings are intended to provide a better understanding of the present invention, but they are in no way intended to limit the scope of the invention.

This patent or application file contains at least one drawing executed in color. Copies of this patent or patent application publication with color drawing(s) will be provided by the Office upon request and payment of the necessary fee.

FIG. 1 is a perspective view in which salient components of a prior art ruling engine are depicted;

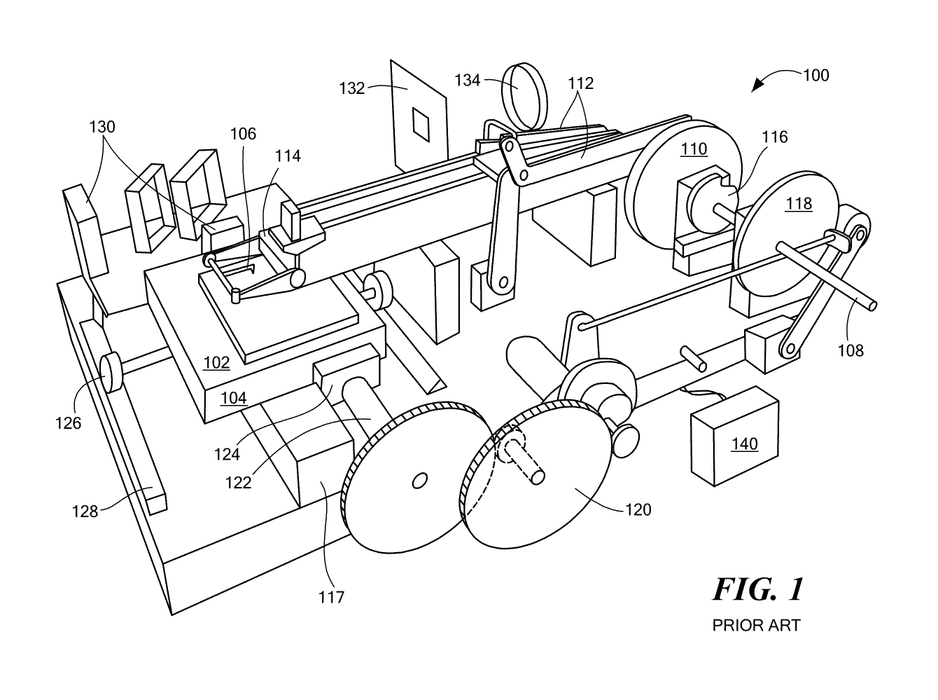

FIG. 2 is a cross-sectional view of a grating ruling apparatus in accordance with an embodiment of the present invention;

FIG. 3 is a cross-sectional view of a diamond-tipped cantilever of an AFM for application in grating ruling in accordance with an embodiment of the present invention;

FIG. 4 is a false-color image showing the depth of a grating surface ruled in accordance with a method taught in the present invention.

### DESCRIPTION OF SPECIFIC EMBODIMENTS OF THE INVENTION

Definitions. As used in this description and in any accompanying claims, the following terms shall have the meanings indicated, unless the context otherwise requires:

The term “grating,” or, interchangeably, “optical grating,” or “x-ray grating” shall refer to a reflection grating comprising grooves ruled into a surface of a material, without limitation as to the composition of the material or to the geometry of the ruling. Within the scope of the present invention, the ruled surface may be planar, but is not so limited. The rulings may be parallel, but are not so limited, as will be discussed below.

In accordance with preferred embodiments of the present invention, the ruling of a grating employs an atomic force microscope.

The atomic force microscope (AFM), invented by Binnig, Quate and Gerber in 1985, is described, generally, in U.S. Pat. No. 4,724,318, Reissued as RE 33,387, both of which patents are incorporated herein by reference. An AFM is characterized by a cantilevered tip used to scan a surface of any composition, with deflection of the cantilever (static or dynamic) typically monitored optically or by means of a tunneling current. With a solid sample mounted to a piezoelectric surface, a closed loop may be employed to maintain a constant force on the tip. As used herein and in any appended claims, the term “atomic force microscope,” or “AFM,” shall refer to any apparatus, now known or to be invented in the future, which may be configured via a feedback mechanism to maintain a constant force on a tool in a direction normal to a specified surface.

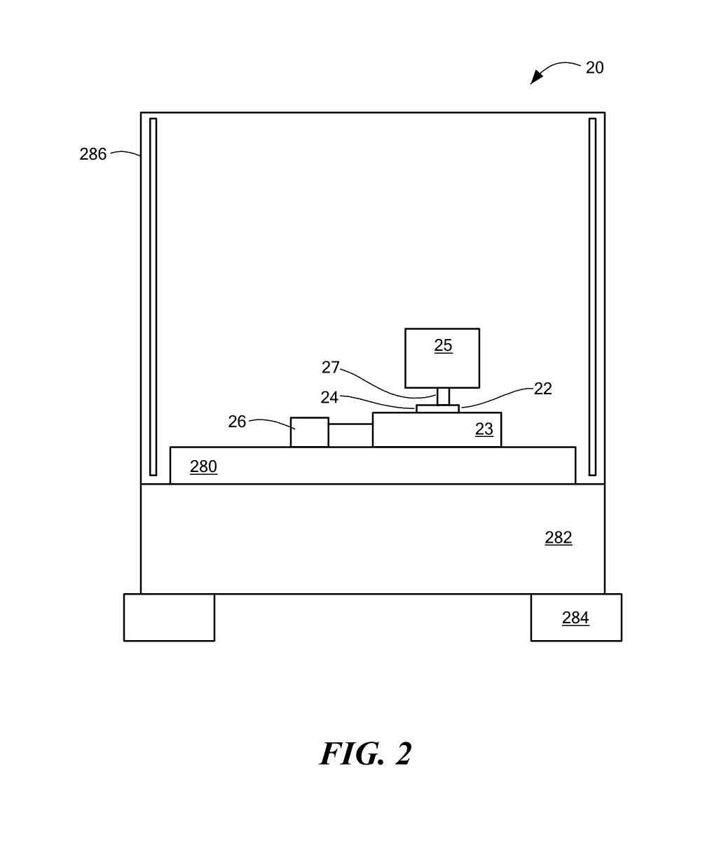

Preferred embodiments of the present invention are now described with reference to FIG. 2, where a ruling apparatus is designated generally by numeral 20. A workpiece blank 22 is coupled to a linear induction stage 23 driven by one or more linear actuators. The coupling between blank 22 and linear induction stage 23 is by any fastening means known in the art that will retain the blank rigidly during the course of ruling. The coupling preferably does not distort the planarity of upper surface 24 of blank 22 if it is planar, or the surface figure of upper surface 24 if it is other than planar. Blank 22 may be any solid material selected for purposes of the diffraction grating which is to be ruled on the surface of the blank.

Linear induction stage 23 incorporates one or more linear actuators that produce motion in a straight line. Linear induction motors (LIMs) are preferred as linear actuators in that the linear motion they produce has no periodic component that may give rise to periodic defects in a ruling. Preferably, by configuration of multiple linear actuators, linear induction stage 23 may be programmed to move blank 22 in any pattern in a transverse (x-y) plane that is desired for a particular grating ruling application. In a preferred embodiment of the invention, a two-axis linear induction stage is provided, having a resolution of 1 nm, as available from Aerotech, Inc., of Pittsburgh, Pa.

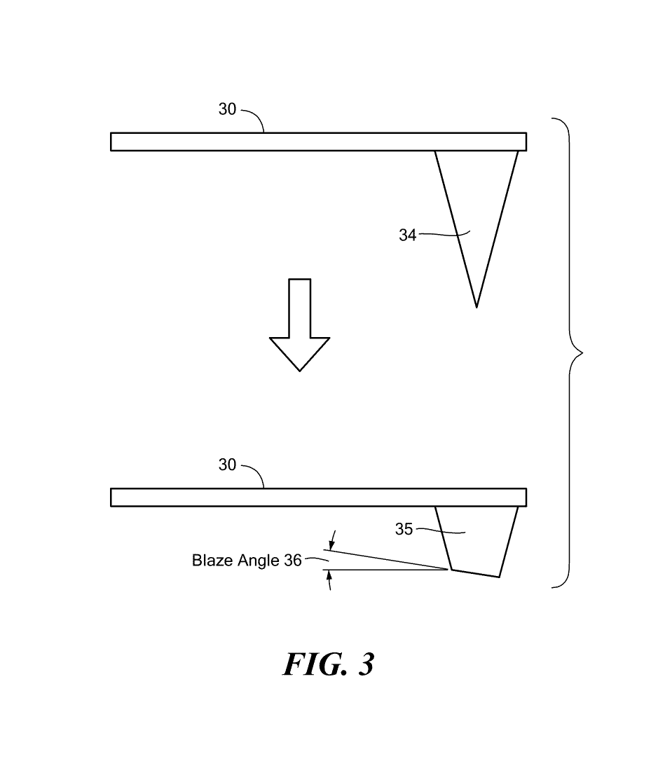

An atomic force microscope (AFM) 25 is disposed with head 27 above workpiece blank 24. Head 27 of AFM 25 includes a ruling tip 34 and 35 shown in FIG. 3 cantilevered by means of cantilever member 30. A suitable AFM may be obtained from AFM Workshop of Signal Hill, Calif. Ruling tip 34 may be a diamond tip, or, within the scope of the present invention, may also be fabricated from other materials, elemental or chemically compound, and may be heterogeneous as in the case of structures coated with diamond, carbon, hafnium diboride, or other materials. For heuristic convenience, ruling tip 34 may be referred to herein as a “diamond tip.” The position of diamond tip 34 relative to upper surface 24 of blank 22 is governed by a closed loop so as to maintain either a constant force on tip 34 relative to upper surface 24, or else a specified displacement in a frame of reference such as that of the linear induction stage. Thus, the force may be adjusted to achieve a specified depth of cut even if the material of the workpiece blank 22 is inhomogeneous.

Diamond tip 35 is preferably shaped so as to produce a specified cut as the blank 22 is translated in a specified direction beneath it. In particular, blaze angle 36 may be optimized to enhance power in specified orders of diffraction, as well known in the optical arts. Diamond tip 35 may be shaped using any of a variety of shaping techniques, such as by lapping, grinding, polishing, etching, or by focused ion beam (FIB) milling, such as described, for example, by Adams et al., Focused ion beam milling of diamond: Effects of H₂O on yield, surface morphology and microstructure, J. Vac. Sci. Technol. B, vol. 21, pp. 2234-43 (2003), incorporated herein by reference, and references cited therein. Other means for shaping diamond tip 35 are also within the scope of the present invention as claimed.

In order to produce “powered” diffraction gratings, upper surface 24 of blank 22 may have a shape other than planar, and may be convex, concave, or some combination thereof. Ruling in accordance with teachings of the present invention is particularly advantageous in such a case, since a constant force may be maintained on the diamond tip despite a variance of blank surface 24 from planarity.

An interferometer 26 allows for concurrent verification of the position of stage 23, and, by implication, blank 22, which is fixedly coupled to the stage.

For stability, components of ruling apparatus 20 may be mounted to a rigid optical breadboard 28 atop a rigid granite block 282, mounted on air legs 284. Ruling apparatus 20 is preferably enclosed within a temperature-stabilized, acoustic enclosure 286.

The application to optics of diamond scribing using an atomic force microscopic is a particular challenge, since optical-wavelength-scale tolerances must be maintained over distances as large as 15 cm.

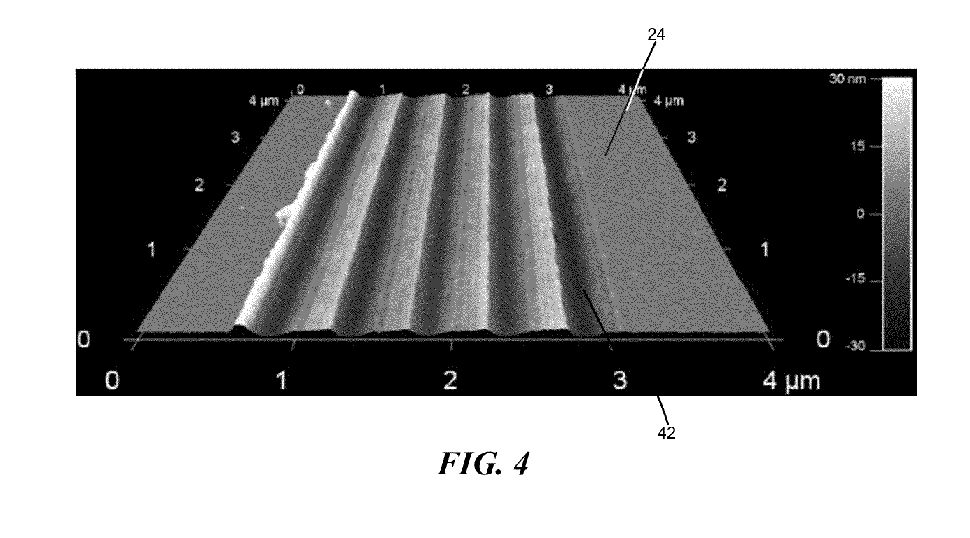

In order to produce a diffraction grating, as for purposes of x-ray diffraction in chemical analysis or imaging, and as shown in FIG. 4, a straight groove 42 is ruled in blank 22, with successive grooves ruled in parallel to neighboring grooves. The spacing between successive parallel grooves may be constant across the blank, or may vary as a function of distance from an edge of the blank. The flexibility of the methods described herein additionally allows for the purposeful introduction of deviations from parallelism of the grooves. For example, if the lines near the center of a diffraction grating are modified to form an e-fold fork dislocation, then the first-order diffracted beam contains an optical vortex, which is to say that the diffracted beam carries orbital angular momentum. In accordance with another example, non-intersecting curved grooves may be ruled, thereby providing for focusing in a lateral direction. Gratings with chirped periods and other aperiodicities engender a wealth of optical effects, by virtue of imparting a frequency-dependent phase shift on an incident beam. Gratings with variable line spacing provide focusing in the dispersive direction and find applications in synchrotron radiation facilities, for example. Tailoring of power in respective diffraction orders, pulse compression and other pulse shaping sample the richness of the phenomenology accessed by the presently described invention.

The embodiments of the invention described herein are intended to be merely exemplary; variations and modifications will be apparent to those skilled in the art. All such variations and modifications are intended to be within the scope of the present invention as defined in any appended claims.

We claim:

1. A method of manufacturing an optical grating, the method comprising:
a. securing a workpiece blank to a surface of a carriage;
b. translating the carriage in a first direction by means of a linear actuator;
c. maintaining a tool in contact with a surface of the workpiece blank at one of a constant force and a constant displacement normal to the surface of the workpiece blank during the step of translating the carriage in a first direction, thereby ruling a groove in the surface of the workpiece blank;
d upon completion of the groove in the surface of the workpiece blank, translating the carriage in a second direction substantially transverse to the first direction; and
e. repeating steps (b), (c) and (d) in such a manner as to rule a plurality of grooves, constituting, in the aggregate, a grating surface.

2. A method according to claim 1, wherein the step of maintaining the tool in contact with the surface of the workpiece blank is performed by means of an atomic force microscope.

3. A method according to claim 1, wherein the tool is a diamond tip.

4. A method according to claim 3, further comprising ion milling the diamond tip to a specified shape.

5. A method according to claim 1, wherein the tool is shaped by a process of polishing.

6. A method according to claim 1, wherein the linear actuator is a linear induction motor.

7. A method according to claim 1, further comprising measuring the translation of the carriage in the second direction by means of an interferometer.

8. A method according to claim 1, further comprising introducing chirped periods into the grating surface.

9. A method according to claim 1, further comprising introducing aperiodicities into the grating surface.

10. An optical grating, manufactured in accordance with any of claims 1-7, having no periodic excursion from parallelism of the plurality of grooves.

11. An optical grating, manufactured in accordance with any of claims 1-7, having specified excursions from parallelism of the plurality of grooves.

12. An optical grating in accordance with claim 10, comprising parallel grooves of variable spacing.

13. An optical grating in accordance with claim 10, having non-intersecting curved grooves.

14. An optical grating, manufactured in accordance with claim 11, wherein a specified excursion from parallelism of the plurality of grooves includes a fork discontinuity.

15. An apparatus for manufacturing an optical grating, the apparatus comprising:
a. a linear actuator for translating a workpiece blank in a plurality of directions relative to a shaped diamond tip; and
b. an atomic force microscope for retaining the shaped diamond tip relative to a surface of the workpiece blank subject to one of a constant force and a constant displacement normal to the surface of the workpiece blank.

16. An apparatus in accordance with claim 15, the linear actuator is a linear induction motor.
